(19) United States
(12) Patent Application Publication
(10) Pub. No.: US 2007/0009112 A1
(43) Pub. Date: Jan. 11, 2007

(54) Dual-mode radio studio

(76) Inventor: Edward Efron, Las Vegas, NV (US)

Correspondence Address: Roy A. Ekstrand, Ste. 150, 3158 Redhill Ave., Costa Mesa, CA, 92618, US

(21) Appl. No.: 11/406,784

(22) Filed: Apr. 18, 2006

Related U.S. Application Data
(60) Provisional application No. 60/672,297, filed on Apr. 18, 2005.

(51) Int. Cl. H04B 1/00

(52) U.S. Cl. 381/119

(57) ABSTRACT

A dual-mode radio studio includes a virtual data bus which is used for exchange of data and program material between associated components of the radio studio system. The virtual data bus facilitates the transfer of both analog and digital communications. A computer having a digital mixer and editor is coupled to the virtual data bus in a digital communication format. A physical mixer having analog faders and other analog devices is coupled to the virtual data bus in analog communication. A plurality of bi-directional analog to digital converters are coupled to the virtual data bus to facilitate the processing of both analog and digital information. A plurality of functional devices such as microphones, disc players, instant replay devices, various tape and cassette decks as well as input devices for telephone use are operatively coupled to the virtual data bus. The system is able to operate in a computer controlled mode in which the computer provides the primary information input and data control within the system or alternatively in an analog mode in which the physical mixer controls the system operation.

### CROSS REFERENCE TO RELATED APPLICATION

This application claims the benefit of and priority under 35 U.S.C. 119(e) of U.S. Provisional Patent Application No. 60/672,297 entitled IMPROVED DUAL-MODE RADIO STUDIO filed Apr. 18, 2005 on behalf of Edward Efron, the disclosure of which is incorporated herein by reference.

### FIELD OF THE INVENTION

This invention relates generally to radio studio equipment and particularly to radio studio equipment operation, design and construction.

### BACKGROUND OF THE INVENTION

Radio broadcast studios are well-known and plentiful in the radio art. From earliest times, studio equipment has allowed engineers to control the studio technology operation. In addition, broadcast studios have been required to allow system operators to set up and format the radio station operation. Finally, radio studio equipment has always been expected to enable radio performers to provide input program material for eventual broadcast. Thus, basically all radio stations include some type of studio performance room within which various program material creation devices such as microphones, tape machines, record players and compact disc systems all being utilized to create or gather the program material for eventual broadcast. Most radio studios further include what may be called the studio system in which technical control and packaging of program material and program output is configured and properly combined within the radio station format for communication or transmission to a radio transmitter sight. From the transmitter sight of course, the station signal baring the modulated program material is broadcast over the airways.

Initially, radio studio engineering and performance was a “hands-on” activity with little or no automated technology being utilized. As time passed however, and technology within the associated arts of radio equipment improved, portions of the studio equipment evolved into digital apparatus functioning under the control of one or more digital computers. For the most part, most radio studios evolved into a type of hybrid operation in which some devices tended to remain the older style analog technologies while other devices utilize the newly emerging digital equipment technologies.

In a generally parallel path to that exhibited by the development of studio technologies, there developed two distinct types of radio studio engineers, operators and performers. One type, typically older and more established professionals, tended to prefer a more hands-on operation and therefore tend to favor analog devices. Such professionals believe that the hands-on operation facilitates a better control and “feel and touch” in operating and/or performing within a radio studio. This approach tends to favor and more effectively utilize the extensive experience that such professionals usually have.

The other type of engineers, operators and performers which have emerged are typically younger and more computer savvy professionals. Such professionals tend to favor a less hands-on and more high-tech operation and performance. Such professionals feel that the use of the highest most sophisticated technology available provides greater flexibility, faster operation and is less experience oriented.

As a result, radio studios tend to be either oriented toward the “old style” technology with many analog devices such as mixer, faders and switches or alternatively, tend to be “high-tech” with the majority or entirety of the studio equipment being controlled by one or more computers. While each type of studio technology enjoys some advantages and suffers some limitations, the likely trend in the coming years will favor a continuing shift toward higher-tech and less hands-on studios.

Whatever technology or trend finally emerges in the radio studio arts, it is clear that the resulting radio studios and their equipment will need to be as reliable as possible. The radial broadcast industry is an industry in which the loss of air time or so called “down time” caused by equipment failure is unacceptable. Radio studio systems which cause excessive down time can not be tolerated by broadcasters no matter how high technology, sophisticated or innovative their systems may be.

There remains therefore a continuing need in the art for an improved radio studio which reconciles the substantially divergent technology preferences between the older more experienced practitioners and the younger more technology oriented practitioners. There remains a further continuing need in the art for ever more efficient and reliable radio studio systems which avoid the disastrous consequences of broadcast down time and revenue loss associated with equipment failure.

### SUMMARY OF THE INVENTION

Accordingly, it is a general object of the present invention to provide an improved radio station. It is a more particular object of the present invention to provide an improved radio station system which is operable in a first mode controlled by a physical mixer or in a second mode controlled by the system computer. It is a still more particular object of the present invention to provide an improved radio station system which may be operated in a “hands-on” analog input configuration or in a “high-tech” digital input configuration.

The present invention improved dual mode radio studio provides an integrated system which functions with high reliability and with dual mode capability. The system is operative under the control of a single operator and is configurable into a mixer controlled mode or a computer controlled mode at the simple touch of a mode switch group. In the mixer control mode, a physical mixer rather than the system computer is in operative control of the system. As a result, the operator is able to exercise manual control of most devices such as faders, switches or the like. In the computer control mode, the devices within the system including the mixer and other devices are under the control of the system computer. In computer control mode, operator control is carried on utilizing the computer interface such as the typical mouse and keyboard inputs to the computer. In this mode, the system processes information digitally and does not use the physical mixer and its associated analog components.

When viewed from another perspective, the present invention provides a dual mode radio studio comprising: a virtual data bus having means for communication of digital and analog information; a computer having a digital mixer and editor coupled to the virtual data bus to provide digital communication therebetween; a mixer having a plurality of analog control input devices, manipulatable by a radio studio operator, coupled to the virtual data bus to provide analog communication therebetween; a plurality of analog functional devices operable for communication of analog information; a plurality of digital functional devices operable for communication of digital information; a plurality of bidirectional digital to analog and analog to digital converters coupling the analog functional devices and the digital functional devices to the virtual data bus; and switch means for selectively configuring the dual mode radio studio in either a first mode controlled by the computer or a second mode controlled by the mixer.

The present invention also provides a dual mode radio studio comprising: a virtual data bus having means for communication of digital and analog information; a computer having a digital mixer and editor coupled to the virtual data bus to provide digital communication therebetween; a mixer having a plurality of analog control input devices, manipulatable by a radio studio operator, coupled to the virtual data bus to provide analog communication, therebetween; a first plurality of functional devices utilizing digital information; a second plurality of functional devices utilizing analog information; a plurality of converters coupling the first and second pluralities of functional devices to the virtual data bus to provide conversion of digital and analog information to and from the pluralities of functional devices and the virtual data bus; and switch means for selectively operating the radio studio under control of the computer or the mixer.

### BRIEF DESCRIPTION OF THE DRAWINGS

The present invention is shown in the various figures attached hereto in which each element maintains the same reference numeral in the various views shown herein and in which:

FIG. 1 sets forth a general block diagram of the present invention improved dual mode radio studio;

FIG. 2 sets forth a more detailed operational block diagram of the present invention improved dual mode radio studio;

FIG. 3 sets forth a table of preferred operational devices and apparatus for use in the present invention improved radial studio;

FIG. 4 sets forth a table of signal flow connections between the operative devices within the present invention improved radio studio.

### DESCRIPTION OF THE PREFERRED EMBODIMENT

By way of overview, the present invention improved dual-mode radio studio provides a virtual data bus which is used for exchange of data and program material between associated components of the radio studio system. The virtual data bus facilitates the transfer of both analog and digital communications. In the inventive system, a computer having a digital mixer and editor is coupled to the virtual data bus in a digital communication format. A physical mixer having analog faders and other analog devices is coupled to the virtual data bus in analog communication. A plurality of bi-directional analog to digital converters are coupled to the virtual data bus to facilitate the processing of both analog and digital information. Finally, a plurality of functional devices such as microphones, disc players, instant replay devices, various tape and cassette decks as well as input devices for telephone use and so on are operatively coupled to the virtual data bus. The inventive system is able to operate in a computer controlled mode in which the computer provides the primary information input and data control within the system or alternatively in an analog mode in which the physical mixer controls the system operation. Thus, in one mode the operator interfaces the system via the computer while in the other mode the operator interfaces the system using the physical mixer.

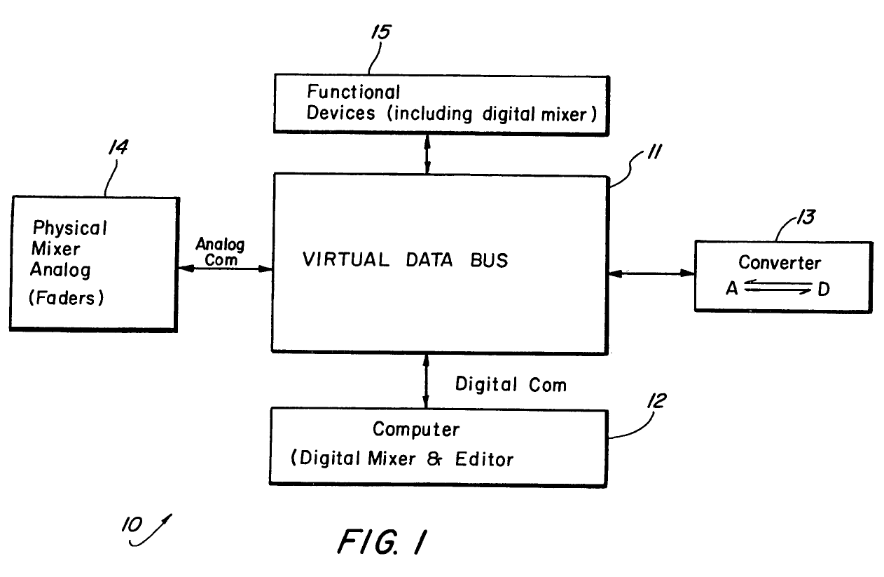

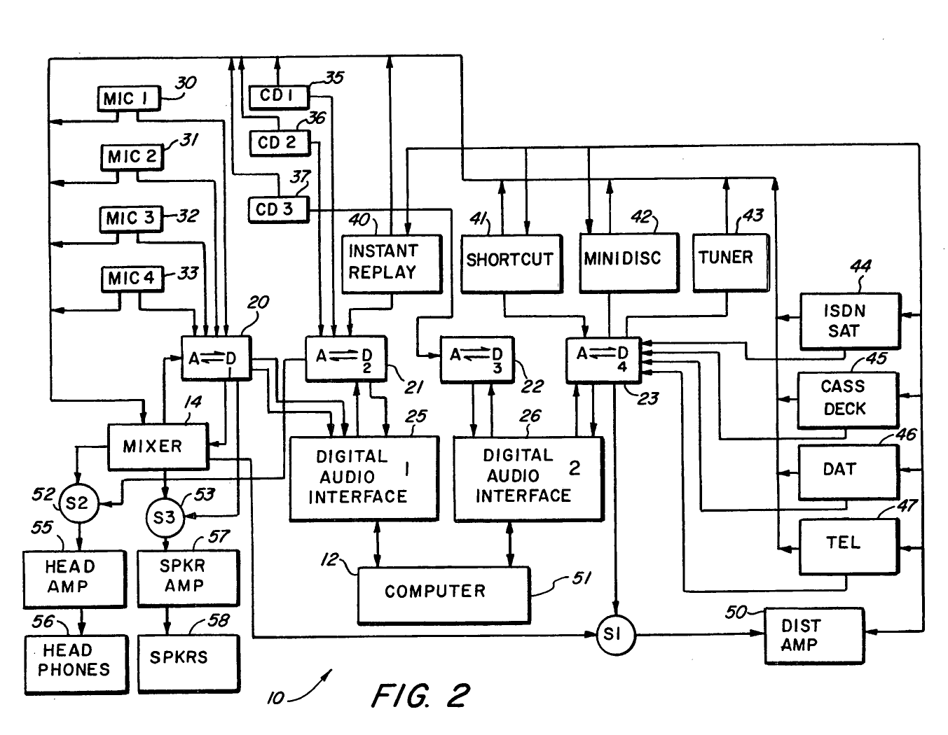

More specifically, and with reference to FIG. 1, an improved dual-mode radio studio is set forth which is generally referenced by numeral 10. Radio studio 10 includes a virtual data bus 11 constructed in accordance with conventional fabrication techniques which includes both digital and analog communication capability. A computer including a digital mixer and editor 12 is operatively coupled to data bus 11 in a bi-directional communication using a digitally formatted communication. Studio 10 further includes a plurality of bi-directional converters generally referenced by numeral 13. Converters 13 are bi-directional in that they perform conversion from analog to digital and from digital to analog information. A physical mixer comprises an analog device having a plurality of analog faders 14 which are operatively coupled to virtual data bus 11 by a bi-directional analog communication link. Finally, radio studio 10 includes a plurality of functional devices 15 which includes a digital mixer. With temporary reference to FIG. 2, the functional devices generally grouped in FIG. 1 and referenced by numeral 15 include a plurality of microphones, a plurality of compact disc players, an instant replay device, a shortcut device, a mini disc player/recorder, a tuner, a ISDN-SATELLITE, a cassette tape deck, a digital tape deck and a telephone interface. It will be apparent to those skilled in the art from the discussion which follow however, that a virtually endless variety of functional devices may be utilized to provide information to and to receive information from data bus 11.

In operation, radio studio 10 is capable of operation in either a computer controlled mode in which computer 12 provides the information interface with the operator and is used by the operator to control system operation. In accordance with the present invention, radio studio 10 is further operable in a mixer controlled mode in which the operator interface and control is applied using physical mixer 14. In the mixer mode, computer 12 remains operative but is operative in a non-controlling functional secondary manner. The selection of operative modes is set forth below in FIG. 2. However, suffice it to note here that a simple switch configuration is sufficient to provide the configuration of radio studio 10 in either the computer controlled mode or the physical mixer control mode.

In operation under computer control, the user provides information and instruction to the remainder of the radio station using typical computer input capabilities including keyboard and mouse. In the computer controlled mode, the digital mixer and editor of computer 12 is utilized in place of physical mixer 14. Thus, digital information is applied to and taken from virtual data bus 11 and exchanged with functional devices 15 to provide system operation. The digital communication carried forward under computer control utilizes the plurality of converters 13 to properly convert digital information and analog information to facilitate digital communication with computer 12 and digital and analog implementation with devices 15.

With the system configured in the physical mixer controlled mode, the function of computer 12 becomes secondary operating under control of the user's inputs using physical mixer 14. Since physical mixer 14 communicates with virtual data bass 11 using analog communication, converters 13 are once again required to provide appropriate conversion between analog and digital formatted information for use by computer 12 and functional devices 15.

With respect to the perspective of radio studio 10 enjoyed by the studio operator, the use of computer controlled mode allows a computer-oriented or “new breed” type of system operator to function comfortably using typical digital communication input devices such as keyboard and mouse. Such new breed operators are more familiar with and more comfortable with the use of typical computer displays and mouse operation to manipulate images which simulate analog devices rather than manipulation of physical devices themselves.

Conversely, from the operators perspective, the operation of radio studio 10 in the mixer controlled mode, utilizes the input apparatus more familiar to the “old school” type of engineer or operator. In this more hands-on method, physical analog devices such as switches and faders are manipulated directly by the system operator or engineer in a hands-on approach. Once again, the operator's input communication from mixer 14 using the analog communication of the mixer are reconciled to the digital devices within the system by converters 13.

As a result, either type of system user is able to employ their particular preference for either computer controlled or physical hands-on mixer control at their choice. The system operation remains invisible to the user regardless of the mode utilized. Operators employing the computer mode see the system as a computer controlled device with all of its inherent characteristics and standard interfaces. Conversely, operators utilizing the physical mixer controlled mode see the entire system as responding to their familiar analog control devices in a hands-on operation.

In accordance with a further advantage dual-mode system, the present invention radio studio is capable of operation in either the computer controlled mode in the event of a failure within the physical mixer or alternatively, operative in the physical mixer controlled mode in the event of a computer failure. This redundancy allows the system to exhibit a substantially increased reliability despite a failure which would incapacitate the prior art systems. Thus, the use of dual-mode operation in the present invention radio studio provides a redundancy which substantially improves the overall reliability of the system and greatly reduces the likelihood of failures which would render the system completely inoperative.

FIG. 2 sets forth a functional block diagram of radio studio 10. Radio studio 10 includes a computer 12 fabricated in accordance with conventional fabrication techniques operatively coupled to a pair of digital audio interface units 25 and 26. Digital audio interface unit 25 is operatively coupled to a pair of bidirectional converters 20 and 21 while digital audio interface 26 is coupled to a further pair of converters 22 and 23. A plurality of microphones 30, 31 and 32 are individually coupled to converter 20 while a plurality of compact disc players 35, 36 and 37 are coupled to converter 21. Microphones 30 through 33 are further coupled to a mixer 14. Mixer 14 is coupled for input and output to converter 20. Mixer 14 is further coupled to a pair of switches 52 and 53. Additionally, converter 20 is coupled to the remaining input of switch 53 while converter 21 is coupled to the remaining input of switch 52. The output of switch 52 is coupled to a headphone amplifier 55 which in turn is coupled to a plurality of headphones 56. Similarly, the output of switch 53 is coupled to a speaker amplifier 57 which in turn is coupled to a plurality of speakers 58. Compact disc players 35 through 37 are further coupled to the input of mixer 14. An instant replay device 40 is coupled to converter 21 and is further coupled to the input of mixer 14. A shortcut device 41 is coupled to converter 23 and is further coupled to the input of mixer 14. A mini disc device 42 is operatively coupled to converter 23 and is further coupled to the input of mixer 14. A tuner 43 is coupled to converter 23 and to the input of mixer 14.

An ISDN/SATELLITE 44 is coupled to converter 23 and is further coupled to the input of mixer 14. A cassette deck player 45 is coupled to converter 23 and is further coupled to the input of mixer 14. A digital tape deck 46 is coupled to converter 23 and is further coupled to the input of mixer 14. A telephone interface 47 is coupled to converter 23 and is further coupled to the input of mixer 14.

A distribution amplifier 50 includes an output operatively coupled to ISDN 44, cassette deck 45, digital tape deck 46 and telephone interface 47. The output of distribution amplifier 50 is further coupled to mini disc unit 42, shortcut unit 41 and instant replay unit 40.

The output of mixer 14 is coupled to the input of mode switch 51. The output of converter 23 is coupled to the remaining input of mode switch 51. The output of mode switch 51 is coupled to distribution amplifier 50.

A pair of mode switches 52 and 53 each have one input thereof coupled to an output of mixer 14. Mode switch 52 has its remaining input coupled to the output of converter 21 while mode switch 53 has its remaining input coupled to the output of converter 20. The output of mode switch 52 is coupled to a headphone amplifier 55 which in turn is coupled to a plurality of headphones 56. The output of mode switch 53 is coupled to speaker amplifier 57 which in turn is coupled to speakers 58.

In operation, the setting of mode switches 51, 52 and 53 provides the configuration of radio studio 10 into either a computer controlled mode or a mixer controlled mode. In the computer controlled mode, the system operation and user interface is carried forward using computer 12 and its associated input devices such as keyboard and mouse. In the computer mode, the input to distribution to distribution amplifier 50 is provided by the connection of converter 23 to the input of distribution amplifier 50 via switch 51. With switch 52 in the computer controlled mode, the input to headphone amplifier 55 provided by switch 52 is coupled from the output of converter 21. Similarly, in the computer controlled mode, the input to speaker amplifier 57 is provided by the coupling of switch 53 to the output of converter 20. Thus, in the computer controlled mode, the input to distribution amplifier 50 and thereby the output provided to devices 40 through 47 originates within the system of computer 12 and is provided by converter 23.

Conversely, in the mixer controlled mode, switch 51 is set to couple the output of mixer 14 to the input of distribution amplifier 50 while simultaneously switches 52 and 53 couple headphone amplifier 55 and speaker amplifier 57 to the outputs of converters 21 and 20 respectively. Thus, in the mixer controlled mode, the user inputs are provided via the interface of mixer 14 and the audio signals applied to headphones and speakers are provided via mixer 14. As a result, radio studio 10 is operative under the control of mixer 14 with computer 12 doing housekeeping and management operations but not utilizing its user interface control.

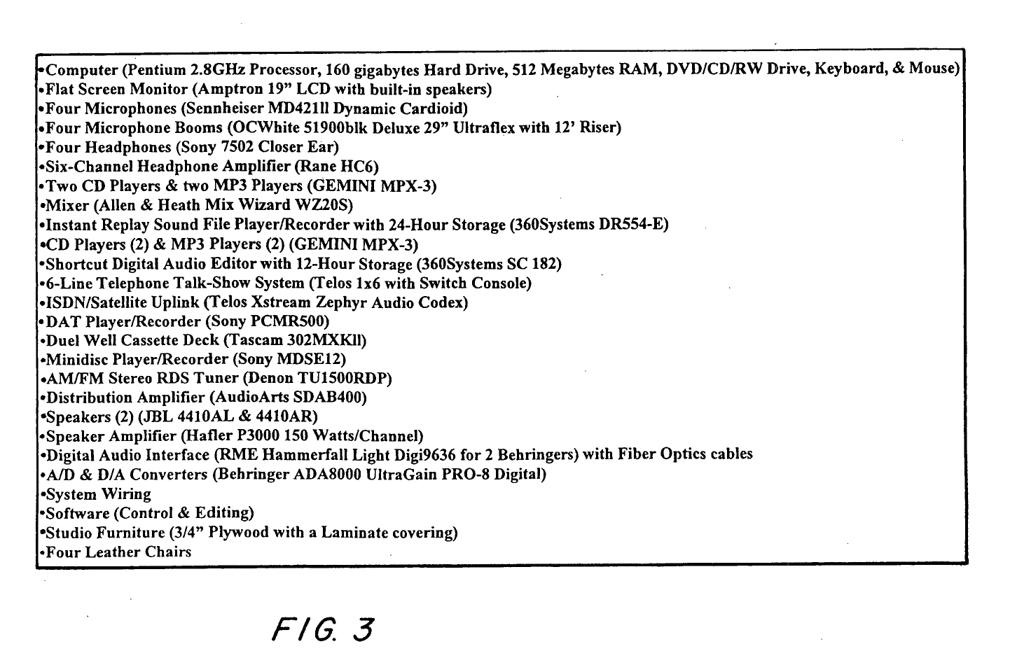

FIG. 3 sets forth a table of preferred system components for use in the present invention radio studio. It will be apparent to those skilled in the art however, that other equivalent components may be utilized in place of the components listed in FIG. 3 without departing from the spirit and scope of the present invention.

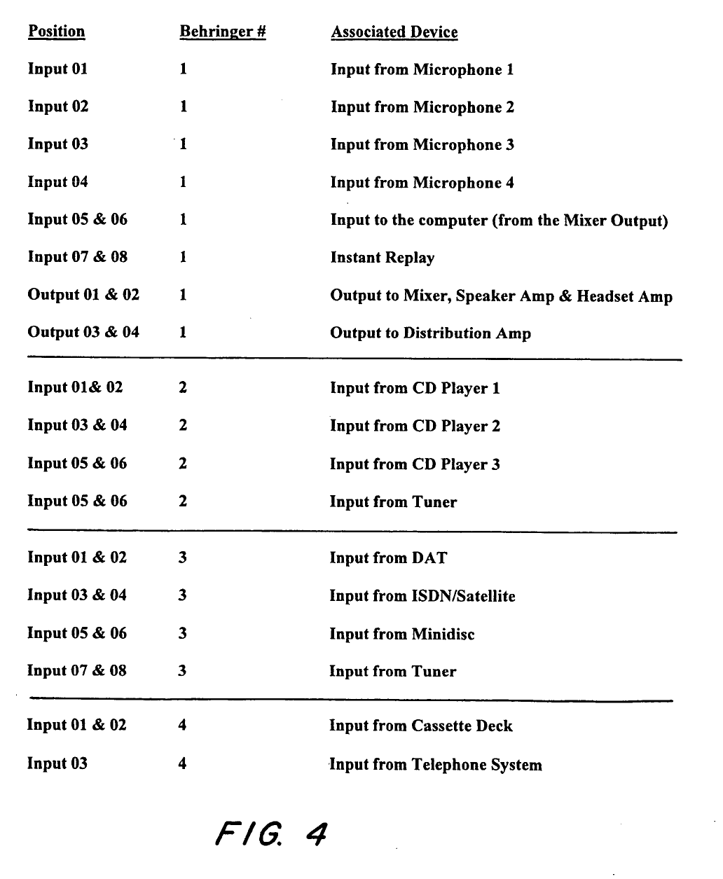

FIG. 4 sets forth a connection list for inputs and outputs to the converters utilized in the present invention radio studio. It will be apparent to those skilled in the art however that other connection schemes of input and output may be utilized without departing from the spirit and scope of the present invention.

What has been shown is a improved radio studio having a dual-mode capability which provides substantial flexibility for operator input preferences together with an increased reliability due to redundancy of control apparatus. The system is operable in either a computer controlled mode in which the user provide input and control utilizing typical computer devices such as keyboard and mouse or alternatively in a mixer control mode in which hands-on analog type devices are used for user interface and control.

That which is claimed is:

1. A dual mode radio studio comprising:
a virtual data bus having means for communication of digital and analog information;
a computer having a digital mixer and editor coupled to said virtual data bus to provide digital communication therebetween;
a mixer having a plurality of analog control input devices, manipulatable by a radio studio operator, coupled to said virtual data bus to provide analog communication therebetween;
a plurality of analog functional devices operable for communication of analog information;
a plurality of digital functional devices operable for communication of digital information;
a plurality of bi-directional digital to analog and analog to digital converters coupling said analog functional devices and said digital functional devices to said virtual data bus; and
switch means for selectively configuring said dual mode radio studio in either a first mode controlled by said computer or a second mode controlled by said mixer.

2. The dual mode radio studio set forth in claim 1 wherein said plurality of analog functional devices includes a plurality of microphones.

3. The dual mode radio studio set forth in claim 2 wherein said analog control input devices includes a plurality of slide-operated fader controls.

4. The dual mode radio studio set forth in claim 3 wherein said plurality of digital functional devices includes an ISDN-SATELLITE system and a digital audio tape recorder/player.

5. A dual mode radio studio comprising:
a virtual data bus having means for communication of digital and analog information;
a computer having a digital mixer and editor coupled to said virtual data bus to provide digital communication therebetween;
a mixer having a plurality of analog control input devices, manipulatable by a radio studio operator, coupled to said virtual data bus to provide analog communication, therebetween;
a first plurality of functional devices utilizing digital information;
a second plurality of functional devices utilizing analog information;
a plurality of converters coupling said first and second pluralities of functional devices to said virtual data bus to provide conversion of digital and analog information to and from said pluralities of functional devices and said virtual data bus; and
switch means for selectively operating said radio studio under control of said computer or said mixer.

6. The dual mode radio studio set forth in claim 5 wherein said analog control input devices includes a plurality of slide-operated fader controls.

7. The dual mode radio studio set forth in claim 6 wherein said plurality of digital functional devices includes an ISDN-SATELLITE system and a digital audio tape recorder/player.

8. The dual mode radio studio set forth in claim 7 wherein said plurality of analog functional devices includes a plurality of microphones.
